(19) United States
(12) Patent Application Publication
(10) Pub. No.: US 2008/0046489 A1
(43) Pub. Date: Feb. 21, 2008

(54) Device and Method for Managing the Content of a File

(76) Inventors: Serge Defrance, Rennes (FR); Ingrid Autier, Domloup (FR); Gael Mace, Langan (FR)

Correspondence Address: Joseph J Laks;Patent Operations, Thomson Licensing Inc., P O Box 5312, Princeton, NJ, 08543-5312, US

(21) Appl. No.: 11/794,409

(22) PCT Filed: Dec. 16, 2005
(86) PCT No.: PCT/EP05/56865

§ 371 Date: Jun. 26, 2007

(30) Foreign Application Priority Data
Jan. 5, 2005 (FR) 0550031

(51) Int. Cl. G06F 12/00

(52) U.S. Cl. 707/206; 707/E17.01

(57) ABSTRACT

The invention relates to a method of managing the content of a file belonging to a file system allocating resource cells of a recording medium to files, the allocation of the cells being structured by so-called structural information. According to the invention the method according to the invention comprises a step of modifying the content of the file by allocating and/or deallocating an integer number of cells at a chosen position of the content of the file, this step of modifying the file being carried out by updating the structural information of the file system. Application to audio/video digital data processing.

The present invention concerns a method and a device for managing the content of a file belonging to a file system allocating resource cells of a recording medium to files. The allocation of the cells is structured by so-called structural information.

The invention relates more particularly to the management of a file containing audio/video data. Such contents represent large quantities of data and require, however, to be processed in real time. Thus file systems based on the use of cells have been developed. These cells are big logical blocks. The basic indivisible unit for storing data may then be a hundred times larger than the conventional sizes used in conventional file systems. A major advantage is that the hard disk reading head does not move too often during real-time processing. Moreover, it is noted that the use of such sizes does not noticeably influence the granularity of storage of the data by virtue of the large size of the files.

In known devices, the processing performed on audio/video data coded in the form of digital data is of great diversity. However, it is observed that today processing such as the slicing of sequences requires equipment of high specificity employing in particular large dynamic memory capacities for storing the data that are to be processed. Such equipment, generally expensive, is often reserved for professionals.

Given the development of mass-market audio/video data write and read devices, the requirement for a solution making it possible to process digital audio/video data in a simple, fast and inexpensive manner exists today.

The present invention proposes to address such a requirement.

In fact, the invention relates to a method of managing the content of a file comprising a step of modifying the content of the file by allocating and/or deallocating an integer number of cells at a chosen position of the content of the file, this step of modifying the file being carried out by updating the structural information of the file system.

Thus, according to the invention, since a file is modified by allocating cells at a given position of the file, it is no longer necessary, when one wishes to modify the size of a file, to extract the stored data from this file to a dynamic memory, to perform the desired modifications of content, for example to add data, before again storing the modified file in a larger number of cells allocated to the end of the original file. The insertion of resource cells at a given and chosen position of the content of the file is rendered possible by direct modification of the structural information. These cells are thereafter used to, for example, copy other data, for example a sequence of a film or advertising pages.

According to an embodiment of the invention, the cells allocated to the file in the modifying step were deallocated from any file before their allocation.

In this case, the invention makes it possible to insert cells at a position of the content of a file so as to modify the size thereof before data are copied into these cells.

According to another embodiment, the cells allocated to the file in the modifying step were allocated to another file before their allocation.

In this case, the invention makes it possible to directly insert the content or a portion of the content of another file. Hence, the cells only change file to which they are allocated. They are not moved or duplicated. On the other hand, they disappear from a file so as to become an integral part of another file.

In an implementation, the chosen position of the content of the file is designated by a number of shift bytes onwards of the start of the content of the file.

In another implementation, the chosen position of the content of the file is chosen from among the start-of-file, current position and end-of-file parameters, the current position being designated by a pointer in the content of the file.

The invention also relates to a device for managing the content of a file implementing a method according to the invention.

The invention also relates to a computer program product comprising program code instructions for the execution of the steps of the method of file management according to the invention, when the said program is executed on a computer.

Other characteristics and advantages of the invention will become apparent with the description offered hereinbelow, by way of nonlimiting example, while referring to the following figures:

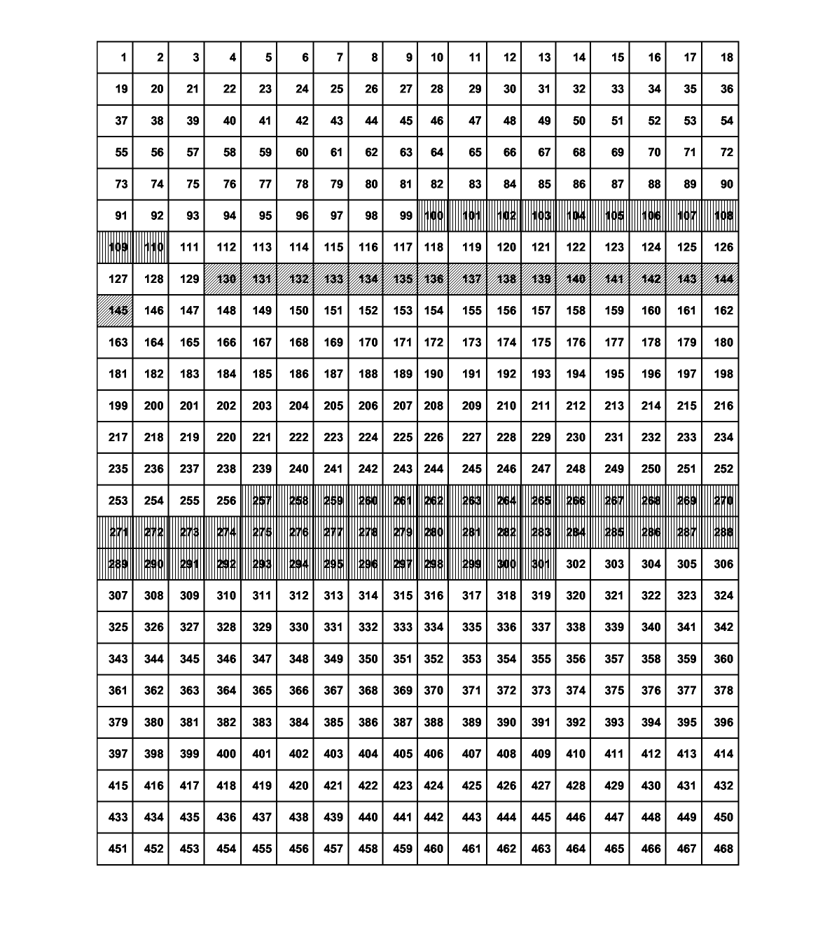

FIG. 1 is an array representing the allocation of storage resource cells.

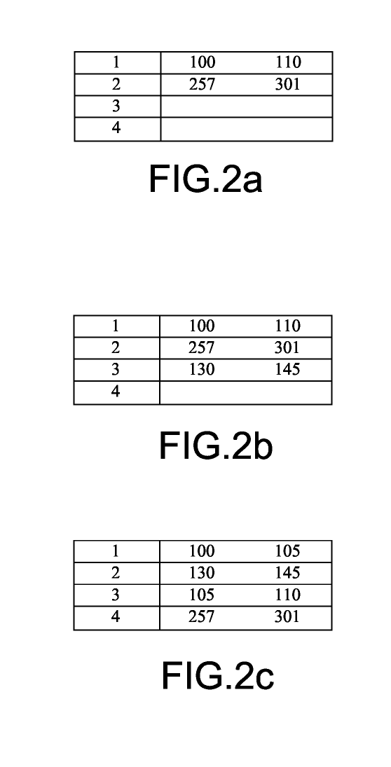

FIGS. 2a, 2b and 2c represent the structural information respectively for a file modified according to the prior art and for a file modified according to the invention.

FIG. 1 represents an array illustrating the allocation of storage resource cells in a file content management device. In this figure, 468 resource cells are represented. These cells are conventionally large logical blocks. For example, the size of a logical block may be of a conventional size, that is to say between 512 and 2048 bytes, or else be of a much more significant size, for example of the order of 128 Kbytes. The use of cells of such a size is especially useful for the processing of audio/video data where the quantity of data to be processed is very large and where such granularity of storage is admissible. According to the structural information as represented in FIG. 2a, a file A employs resource cells 100 to 110 and 257 to 301, represented vertically hatched in FIG. 1.

According to the file systems of the prior art and as represented in FIG. 2b, the size of a file may be modified by adding a certain number of cells, here 16 cells, at the end of the file, from 130 to 145. In this case, to add data at a particular position of the content of a file, it is necessary to extract the data from the resource cells, to send them to a dynamic memory so as to add the data to the appropriate position before saving the modified file in the entirety of the cells newly allocated to the file.

Such a modus operandi involves extensive use of the dynamic memory and may also give rise to losses in regard to storage resource, for example when a content is simply copied from one file to the other and nevertheless remains replicated in the storage resources after copying.

According to the invention, as represented in FIG. 2c, the content of the file is modified by allocating resource cells 130 to 145 at a determined position, after cell 105, of the file. Thus the invention makes it possible to allocate cells to the content of the file anywhere in the file by manipulating the structural information. The invention also makes it possible to modify the content by deallocating resource cells and, hence, to reduce the size of the file. The function for modifying the content of the file according to the invention possesses three parameters: the file to be modified, the size of the new file, the position onwards of which cells are to be inserted or erased. These parameters are chosen by a user.

It is noted that the difference between the sizes of the new and the old file must be an integer number of resource cells. The length indicated in the parameters may however be expressed in bytes so that the difference in size between the old and the new file is expressed in bytes also. The function then converts this value into an integer number of resource cells.

For example, such a conversion may be effected by an integer division of the difference between the old and the new file by the size of the cells or by the multiple of the size of the cells that is closest to the difference between the old and the new file.

After this conversion, the file's actual size, advantageously returned by the function in the form of an integer, may differ slightly from the size given as parameter.

The position onwards of which cells are to be inserted or erased may be indicated differently according to the implementation of the invention. According to a first implementation, the position is indicated by a number of bytes and the given parameter is a shift in bytes (number of bytes with respect to the start of the file). According to a second implementation, the position parameter is chosen from among three values: Beginning_Of_File, Current_Position, End_Of_File. In this case, a read pointer placed in the file designates the position Current_Position.

Thus the format of the function, denoted Modification_Size is advantageously:

(Size_Actual_Of_File_After_Modification) Modification_Size (File_To be_Modified; Size_Required; Position)

This function may be, for example, used within the framework of an off-line reading application (known as a Time Shift application). Such a term designates a recording simultaneous with a reading of one and the same file. In this case, the means of storage, for example a hard disk, is considered to be a buffer memory. In this case, the function for modifying the size of the file is called automatically by the off-line reading device. Two sizes of file are defined, for example by the user: MAX_SIZE and MIN_SIZE. These values correspond to the maximum and to the minimum that are envisaged for the duration between reading and writing. Thus, each time that MAX_SIZE is reached, the size modification function is called with MIN_SIZE as Size_Required parameter and, according to the second implementation, Beginning_Of_File as Position. The function thus makes it possible to deallocate the start-of-file cells.

This function may also be used in editing applications when the contents of various files are to be brought together or when the data of a file are to be inserted into another. In this case, a user can control the parameters so as to effect modifications in a file. For example, he may wish to insert a holiday film sequence stored in a file B at a specific location of a set of family films stored back-to-back in a file A. In these latter applications, the user places the read pointer at the position where he wishes to insert the sequence. The function is then called with the file A as parameter for the File_To be_Modified parameter, the size of the sum of the sizes of the files A and B for the Size_Required parameter and Current_Position for the Position parameter. The function then calculates the final actual size Size_Actual_Of_File_After_Modification on the basis of the Size_Required parameter and inserts the quantity of cells by modifying the structural information. The content of the file B must thereafter be transferred into the cells newly allocated to the file A. It is noted that the cells newly allocated to the file were deallocated from any file before being allocated thereto. The function therefore chooses the cells to be allocated in the file size modification step from among those which are not allocated. In this instance, in FIG. 1, the cells 130 to 145 form part of the cells not allocated before so being to the file A.

This modus operandi involves the use of a buffer memory in which the content of the file B is stored after reading and before writing in the file A. It is also noted that the file B still exists and has not been modified: the content of the file B has only been duplicated in the file A.

In an embodiment, the invention proposes to modify the size of the file by inserting the cells of the file B directly into the file A using the structural information directly. Thus, once the content or a portion of the content of a file B has been inserted into the file A, this content or this portion is no longer considered to form part of the file B. The Insertion_Content function thus proposed makes it possible for the memory occupied, and hence the quantity of occupied cells, not to be increased since the cells are just transferred from one file to another. This function is complementary to the previous one, it has five parameters: the file from which the content is to be transferred, the file into which the content is to be transferred, the position onwards of which the content is to be transferred in the file from which the content is to be transferred, the position onwards of which the content is to be transferred in the file into which the content is to be transferred, the length of the content to be transferred.

Here again, the size to be transferred can be expressed in bytes, in which case, the function recalculates an integer number of cells that is closest to the length of the content to be transferred. The function returns the actual size of the content to be inserted.

This function therefore takes the following form:

(Size_Actual_Of_Content_To be_Inserted) Insertion_Content (File_Source; File_Destination; Position_Source; Position_Destination; Length).

Such a function may be used in numerous applications, in particular editing. Thus, in the example proposed above, the insertion of a file B into a file A may be done directly by using this function and without any physical transfer of data. One thus avoids the use of a buffer memory and hence its congestion, or even its saturation should the quantities of data processed be too large. In this application, the user places the read pointer at the position at which he wishes to insert the content of the file B. Thereafter, the Insertion_Content function is called with file A as the File_Destination parameter, file B as the File_Source parameter, Current_Position as Position_Destination parameter, Beginning_Of_File as Position_Source parameter, and size of the content of B as Length parameter. After the transfer, file B still exists but its size is zero. In the case where only a portion of file B is to be inserted, a read pointer placed in file B designates the position Current_Position for the second implementation. According to the first implementation, the position being indicated by a number of bytes, the use of pointers while reading is not useful, only the shift in bytes (number of bytes with respect to the start of the file) will be indicated as Position_Source parameter.

Thus, in reality, when the content of file B is inserted into file A, no transfer of content is performed. Only the structural information is updated. In FIG. 1, this amounts to saying that cells 130 to 145 are the content of file B.

By virtue of the invention, a file containing data stored in storage cells can therefore be modified piecemeal. A piecemeal modification such as this is accomplished through the manipulation of structural information, directly through the modification command and only through this command. This modification command may be offered to a user or be automated, for example, in an off-line readout application.

The invention is not limited to the embodiments described and to the applications described, the person skilled in the art will recognize the existence of diverse variant embodiments such as for example the movement of data internally to a file without using dynamic memory.

1. Method of managing the content of a file belonging to a file system allocating resource cells of a recording medium to files, the allocation of the cells being structured by so-called structural information, wherein the method of managing the file content comprises a step of modifying the content of the file by allocating and/or deallocating an integer number of cells at a chosen position of the content of the file, this step of modifying the file being carried out by updating the structural information of the file system, said number of cells and said position being specified by the user through functions.

2. Method according to claim 1, in which the allocated cells were deallocated from any file before their allocation.

3. Method according to claim 1, in which the allocated cells were allocated to another file before their allocation.

4. Method according to claim 1, in which the chosen position of the content of the file is designated by a number of shift bytes onwards of the start of the content of the file.

5. Method according to claim 1 in which the chosen position of the content of the file is chosen from among the start-of-file, current position and end-of-file parameters, the current position being designated by a pointer in the content of the file.

6. Device for managing the content of a file of digital audiovisual data, the said device having available a recording medium including resource cells allocated to files in a file system, the said allocation being structured by so-called structural information, the said device comprising a module for modifying the content of the file by allocating and/or deallocating an integer number of cells at a chosen position of the content of the file by updating the structural information of the file system.

7. Computer program product comprising program code instructions for the execution of the steps of the method of file management according to claim 1, when the said program is executed on a computer.
